(19) United States
(12) Patent Application Publication
(10) Pub. No.: US 2005/0241168 A1
(43) Pub. Date: Nov. 3, 2005

(54) PWB warp gauge

(76) Inventors: Raymond Joseph Iannuzzelli, Amherst, NH (US); Anand Avinash Kulkarni, Richardson, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/834,657

(22) Filed: Apr. 29, 2004

(51) Int. Cl. G01B 5/25

(52) U.S. Cl. 33/533

(57) ABSTRACT

According to one embodiment, the present invention comprises an apparatus having a base structure, a measuring structure, and a linking mechanism coupled to the base structure. The exemplary apparatus also includes an output device configured to determine the position of the measuring structure with respect to the base structure in response to a substrate disposed between the measuring structure and the base structure to indicate a quantity of warpage in the substrate.

### BACKGROUND

Traditional computer devices have relatively complex wiring schemes that interconnect various electrical components of the computer device to one another. Certain computer devices employ printed wiring boards (PWBs) (also commonly known as printed circuit boards or PCBs) as part of this wiring scheme. PWBs typically include one or more flat sheets of a rigid material onto or between which communication paths for the various electrical components are etched. PWBs also provide a support structure onto which the various electrical components may fasten. Accordingly, PWBs provide an electrical component assembly that is convenient, compact, and easy to install.

As one example, a microprocessor mounts to a PWB via an intermediary, such as an interposer. Typically, an interposer, which is mechanically and electrically coupled to the PWB, includes a number of sockets configured to receive communication pins located on the microprocessor to mechanically and electrically couple the microprocessor to the PWB. The interposer provides clamping forces to grasp the pins of the microprocessor and secure the microprocessor to the PWB.

However, warpage of the PWB affects the mechanical and electrical connections between the interposer and the microprocessor. For example, warpage of the PWB, if not accounted for, causes misalignment between the sockets of the interposer and the pins of the microprocessor, thereby potentially degrading performance of the computer device (e.g., damaging the pins of the microprocessor). Moreover, warpage of the PWB decreases the clamping forces provided by the socket springs of interposer, thereby potentially weakening the physical and electrical coupling between the PWB and the microprocessor. For example, warpage of the PWB may prevent the interposer from applying clamping forces sufficient to achieve an appropriate level of contact compression between the interposer and the microprocessor.

Traditional techniques to determine warpage of a PWB (e.g., optical comparison) consume an inordinate amount of resources and/or time. Accordingly, typical computer component manufacturers over-design their products to account for a broad range of PWB warpages, rather than expending resources to accommodate for the effects of this warpage. For example, an interposer may be over-designed to accommodate for the reduction in clamping forces caused by relatively extreme PWB warpage conditions, which are not typically present. This leads to unnecessary costs in fabrication and design.

### BRIEF DESCRIPTION OF THE DRAWINGS

FIG. 1 is a side view of an exemplary processor assembly coupled to a PWB, in accordance with an embodiment of the present invention;

FIG. 2 is a side view of the processor assembly of FIG. 1 in which an amount of PWB warpage is illustrated;

FIG. 3 is a representation of an embodiment of a warpage measuring system, in accordance with the present invention;

FIG. 4 is a flowchart illustrating in block form an exemplary process for measuring warpage, in accordance with an embodiment of the present invention; and

FIG. 5 is a flowchart illustrating in block form an alternate exemplary process, in accordance with an embodiment of the present invention.

### DETAILED DESCRIPTION

Embodiments of the present invention provide systems, methods, and apparatus for determining an amount of warpage in a substrate, such as a printed wiring board (PWB) or another relatively flat and thin support structure. One exemplary measuring apparatus comprises a measuring plate, a base plate, and a linking mechanism. An output device is configured to determine the position of the measuring plate with respect to the base plate and, as such, indicates a quantity of warpage in the PWB. As a result, design of a component coupleable to the PWB (e.g., an interposer) may be optimized in accordance with the amount of warpage in the PWB indicated by the measuring device. As another example, the indication of warpage may assist in quality control protocols in which PWBs falling outside desired parameters are rejected.

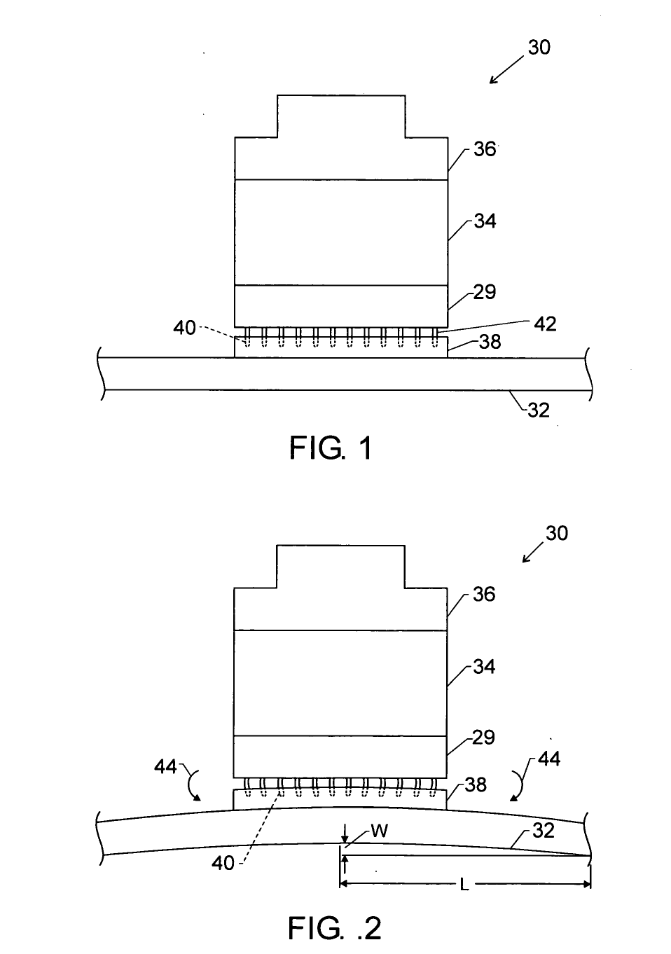

FIG. 1 illustrates an exemplary processor assembly 30 coupled to a substrate, which in the present embodiment is a PWB 32. Other examples of substrates include a host of relatively flat and thin support structures. Embodiments of the present invention provide advantages to a broad spectrum of electronic devices, such as a computer, pager, cellular telephone, personal organizer, control circuit, etc. It will be appreciated that the following discussion of a processor-based device is only one example of an electronic device having a PWB. In a processor-based device, a processor 29, such as a microprocessor, controls many of the functions of the device. The exemplary PWB 32 includes a number of etched conductive pathways for communications between the processor 29 of the processor assembly 30 and the various other components of the processor-based device. During operation, the processor 29 produces heat. Accordingly, the processor assembly 30 includes components for dissipating this heat. For example, the processor assembly 30 includes a heat sink 34 coupled to the upper surface of the processor 29. The exemplary heat sink 34 comprises a metallic material, such as aluminum, and convectively dissipates heat produced by the processor 29. Additionally, the exemplary processor assembly 30 includes an active cooling device, such as a cooling fan 36. By generating airflow, the cooling fan 36 also increases the efficacy of cooling across the heat sink 34 and the processor 29, thereby more effectively dissipating heat produced by processor 29.

In FIG. 1, the processor 29 couples to the PWB 32 through an intermediary structure, such as an interposer 38, which is secured to the PWB 32. The exemplary interposer 38 includes a plurality of sockets 40, which receive correspondingly spaced pins 42 extending from the bottom side of the processor 29. The sockets of 40 of the interposer 38 are in electrical communication with the electrical pathways of the PWB 32. Accordingly, by aligning and inserting the pins 42 of the processor 29 with respect to the sockets 40, the processor 29 is brought into electrical communication with the electrical pathways of the PWB 32. That is to say, the interposer 38 electrically couples the processor 29 to the PWB 32, thereby electrically coupling the processor 29 to any number of components of the processor-based device. Moreover, the interposer 38 mechanically couples the processor 29 and the processor assembly 30 to the PWB 32.

The PWB 32 may present an amount of warpage that affects the engagement between the processor 29 and the interposer 38, as illustrated in FIG. 2. This warpage may result as a function of environmental conditions and/or manufacturing conditions, to name but a few causes. In any event, sufficient warpage in the PWB 32 causes the interposer 38, which is secured to the PWB, to warp as well. In FIG. 2, the amount of warpage within the PWB 32 and the corresponding interposer 38 is exaggerated for the purposes of illustration. However, warpage as small as 0.018 inches (0.4752 mm) or less may affect the processor assembly 30. In any event, sufficient warpage of the PWB 32 causes misalignment between the pins 42 of the processor 29 and the sockets 40 of the interposer 38.

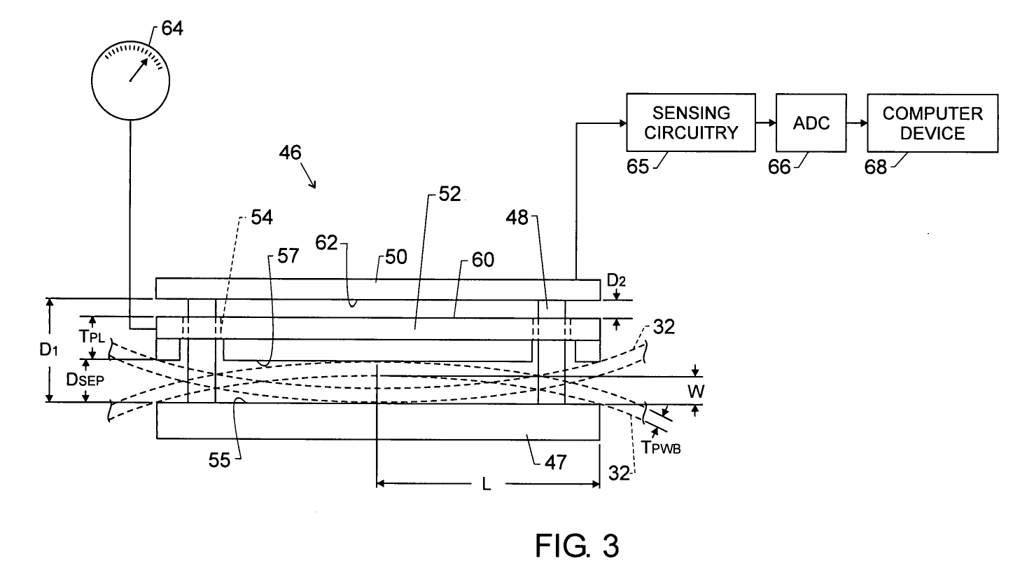

In the discussed embodiment, the distance W represents the amount of warpage in the PWB 32, which may be a function of the measured length of the PWB 32. That is to say, because of the sloped nature of warpage, the value of W generally increases as L increases. However, the significance of the measured distance L on W may decrease as the value of W is dwarfed by the overall length L of the measuring plate (see FIG. 3). That is, the measured W distance reaches a maximum value.

Although the sockets 40 may receive the pins 42, sufficient warpage of the PWB 32 produces undesired forces that affect the interaction between the pins 42 and sockets 40. For example, undesired moment forces, represented by directional arrows 44, affect the processor assembly 30 by reducing the clamping forces produced by socket springs. If not accounted for, the warpage of the PWB 32 leads to unwanted separation of the processor 29 and the processor assembly 30 from the interposer 38. Additionally, the exemplary moment forces 44, if sufficient and unaccounted for, cause damage to the pins 42 of the processor 29, leading to degradation in the performance of the device. Indeed, in certain instances, the warpage of the PWB 32 may entirely prevent coupling of the processor 29 with the interposer 38 all together. By measuring the warpage of the PWB 32, various components (e.g., the processor 29 and the interposer 38) may be designed to accommodate the warpage.

In other embodiments, measuring the amount of warpage in the PWB 32 is employed in conjunction with quality control protocols. For example, a raw (i.e., unassembled) PWB 32 is measured to determine the amount of warpage it presents. If the amount of warpage exceeds pre-determined parameters, the quality control protocols may call for rejection of the PWB 32. Accordingly, the PWB 32 is discarded prior to assembly of electrical components thereon. Such pre-emptive rejection prevents waste, because the PWB is discarded prior to the discovery of warpage in the final stages of assembly, when many of the electrical components may have already been secured to the PWB 32.

FIG. 3 illustrates an exemplary measuring device 46 for measuring an amount of warpage in a PWB 32. Again, the amount of warpage illustrated in the PWB 32 is exaggerated for the purposes of illustration and explanation, and is represented by distance W. Again, an amount of warpage in a PWB 32 as small as 0.018 inches or less may affect the interposer 38 (see FIG. 2) as well as the coupling of electronic components to the exemplary PWB 32. The exemplary measuring device 46 includes a base structure, which is illustrated as a backing plate 47 in the present exemplary embodiment. The measuring device 46 also includes a linking mechanism, which is illustrated as posts 48 that extend in a perpendicular direction from the backing plate 47 in the present exemplary embodiment. The backing plate 47 may comprise a hard, corrosion-resistant material, such as stainless steel, for use in industrial settings. Of course, any number of suitable materials may form the backing plate 47, such as plastics. Additionally, the exemplary measuring device 46 includes a top structure, which is illustrated as the top plate 50 in the present exemplary embodiment. The top plate 50 interacts with and is disposed across the posts 48. The exemplary top plate 50 is formed of a hard, corrosion-resistant material, of course, other materials, such as plastics, may also be envisaged.

The exemplary measuring device 46 comprises a measuring structure, which is illustrated as a measuring plate 52 in the present exemplary embodiment, located intermediate the top and backing plates, 50 and 47, respectively. As illustrated, the exemplary measuring plate 52 presents a uniform thickness (T_{PL}). Advantageously, the uniform thickness (T_{PL}) of the measuring plate 52 facilitates consistent measurements across the length of the measured PWB 32. However, the measuring plate 52 may also present non-uniform, known thickness values. The measuring plate 52 engages with the posts 48 such that the measuring plate 52 is positionable between the top plate 50 and the backing plate 47 along the posts 48. For example, the measuring plate 52 includes apertures 54 that respectively receive the posts 48. The posts 48 interact with the apertures 54 of the measuring plate 52 such that the measuring plate 52 slides along and is guided by the posts 48. That is, the posts 48 define the path of travel of the measuring plate 52 with respect to the backing plate 47 and the measuring device 46 as a whole. In other words, the posts 48 act as a linking mechanism that facilitates positioning of the measuring plate 52 with respect to the backing plate 47 and the measuring device 46 as a whole. Additionally, the top plate 47 acts a barrier that limits movement of the measuring plate 52 along the posts 48 and, as such, limits the path of travel of the measuring plate 52. Although the measuring, top, and base structure are presently described as plates, other structures are envisaged. For example, in alternate embodiments, the measuring, top, and base structures may comprise an assembly of components presenting non-uniform thicknesses and/or arcuate surfaces and edges.

With respect to the orientation of FIG. 3, the top surface 55 of the backing plate 47 and the bottom surface 57 of the measuring plate 52 cooperate to define a region configured to receive a PWB 32. The PWB 32 is illustrated in dashed line in the present figure. A PWB 32 appropriately positioned in the measuring device 46 causes the measuring plate 52 and the backing plate 47 to maintain a separation distance (D_{SEP}). That is, D_{SEP} represents the distance between the bottom surface 57 of the measuring plate 52 and the top surface 55 of the backing plate 46. For example, if no PWB 32 is located between the measuring plate 52 and the backing plate 47, the positionable nature of the measuring plate 52 enables the bottom surface 57 of the measuring plate 52 to abut directly against the top surface 55 of the backing plate 47. Accordingly, D_{SEP} essentially equals zero when no PWB 32 is present. However, if a PWB 32 is placed between the measuring plate 52 and the backing plate 47, the PWB 32 maintains a separation distance (D_{SEP}) between the two plates and prevents the two plates from abutting against one another. Accordingly, the PWB 32 defines the separation distance, D_{SEP}. By measuring the separation distance (D_{SEP}) between the two plates, the measuring device 46 indicates the amount of warpage in the PWB 32.

For example, a typical PWB 32 presents a uniform thickness, represented as T_{PWB} in FIG. 3. To ease explanation, the following discussion relates to a PWB 32 having a uniform thickness T_{PWB}. However, it should be noted that embodiments of the present invention are equally applicable to non-uniform PWBs in which specific thickness dimensions are known. Moreover, embodiments of the present invention are also applicable to compare the relative amounts of warpage between PWBs, even if the thicknesses of the PWBs are unknown. If the PWB 32 is not warped, the PWB 32 maintains a D_{SEP} valve equal to the thickness of the PWB 32 (i.e., T_{PWB}), because the PWB 32 rests flushly against the upper surface 55 of the backing plate 47 and the lower surface 57 of the measuring plate 52. That is, over the measured distance L, the PWB presents essentially no warpage. However, if the PWB 32 is warped, the sloped nature of the warped PWB increases the minimum separation distance (D_{SEP}) between backing plate 47 and the measuring plate 52 over the measured length L in comparison to an unwarped PWB. For example, because of the warpage in the PWB 32, the PWB 32 arcs within the measuring device 46 and no longer rests flushly against the surfaces of the measuring plate 52 and the backing plate 47. Rather, the arced nature of the warped PWB 32 causes the separation distance (D_{SEP}) to be defined by tangential points of the PWB 32 that engage with the plates 47 and 52 respectively. Thus, D_{SEP} is greater than T_{PWB}. Accordingly, the difference between D_{SEP} and T_{PWB} indicates the amount of warpage in the PWB 32 and may be represented as:
W or PWB_{WARP}=D_{SEP}−T_{PWB}.

Alternatively, the distance between the top surface 60 of the measuring plate 52 and the bottom surface 62 of the top plate 50 in the measuring device 46 may also be a function of the warpage of the PWB 32. This distance between the measuring plate 52 and the top plate 50 is illustrated in the instant figure as D₂. Thus, by determining the value of D₂, a value indicating the amount of warpage in the PWB 32 may be determined. For example, an indication of the valve of warp in the PWB 32 may be represented by:
W or PWB_{WARP}=D₁−T_{PL}−T_{PWB}−D₂.

In the exemplary measuring device 46, a number of the dimensions of the respective components and the relationships therebetween may be constant. For example, the distance between the top surface 55 of backing plate 47 and the bottom surface top plate 50 is constant, which is represented in FIG. 3 as D₁. Additionally, the thickness of the PWB 32, which is represented as T_{PWB}, as well as the thickness of the measuring plate 52, represented as T_{PL}, may be constant as well. Because the thickness of the measuring plate 52 (i.e., T_{PL}) as well as the distance between the backing plate 47 and the top plate 50 (i.e., D₁) may be constant, the formula may be distilled to the following:
PWB_{WARP}=CONSTANT−T_{PWB}−D₂.

Again, the uniformity of thickness in the measuring plate 52 and the PWB 32 simplifies explanation of embodiments of the present invention. However, it should be understood that embodiments of the present invention are equally applicable to PWBs and/or measuring plates that present non-uniform thickness. Additionally, the quantity of warpage in the PWB is determinable through the use of ratios. For example, as the quantity of warpage in the PWB (W) increases, the value of D_{SEP} also increase and the value of D₂ decreases. Accordingly, the warpage in the PWB may be represented as:

$$W ∝ \frac{{D}_{SEP}}{{D}_{2}} .$$

To measure the distance between the measuring plate 52 and the top plate 50 or the measuring plate 52 and the backing plate 47, the measuring device 46 comprises an output device, such as an analog gauge 64 that provides an indication of the position of the measuring plate 52 and of the distance between the measuring plate 52 and the base plate 47 and or the top plate 50. The analog gauge 64 displays the location of the measuring plate 52, which may be represented by D₂ or D_{SEP}, for example. By way of example, the analog gauge 74 may comprise a micrometer. Alternatively and/or additionally, the output device may comprise electronic circuitry that provides the position of the measuring plate 52 as defined by the PWB 32. For example, at least one of the posts 48 may include a linear voltage transformer (LVT) that produces a voltage signal representative of the position of the measuring plate 52 with respect to the post 48. The LVT produces a signal having a voltage level that is determined by the position of the measuring plate 52 with respect to the post 48. For example, the contact between the measuring plate 52 and the lower end of the post 48 may produce a lower voltage signal than contact between the measuring plate and the upper end of the post. Accordingly, as the measuring plate 52 is moved towards the top plate 50 and away from the backing plate 47, the voltage of the signal produced by the LVT increases.

Sensing circuitry 65 receives this voltage signal from the LVT and transmits an analog signal representative of the analog voltage signal to analog-to-digital conversion (ADC) circuitry 66. In turn, the ADC circuitry 66 converts this analog signal into a digital signal, which is transmitted to a computer device 68. The computer device 68 may perform any number of tasks based upon the received digital signal. For example, the computer device 68, via a computer program, may calculate the PWB warpage via the formulas discussed above. Moreover, the computer device 68 may determine if the amount of warpage in the PWB 32 exceeds desired parameters and, as such, should be discarded. The measuring device 46 may be incorporated into an assembly process for use with quantity control protocols. In some embodiments, the measuring device 46 provides a portable tool for “spot-checking” PWB 32 fabrications.

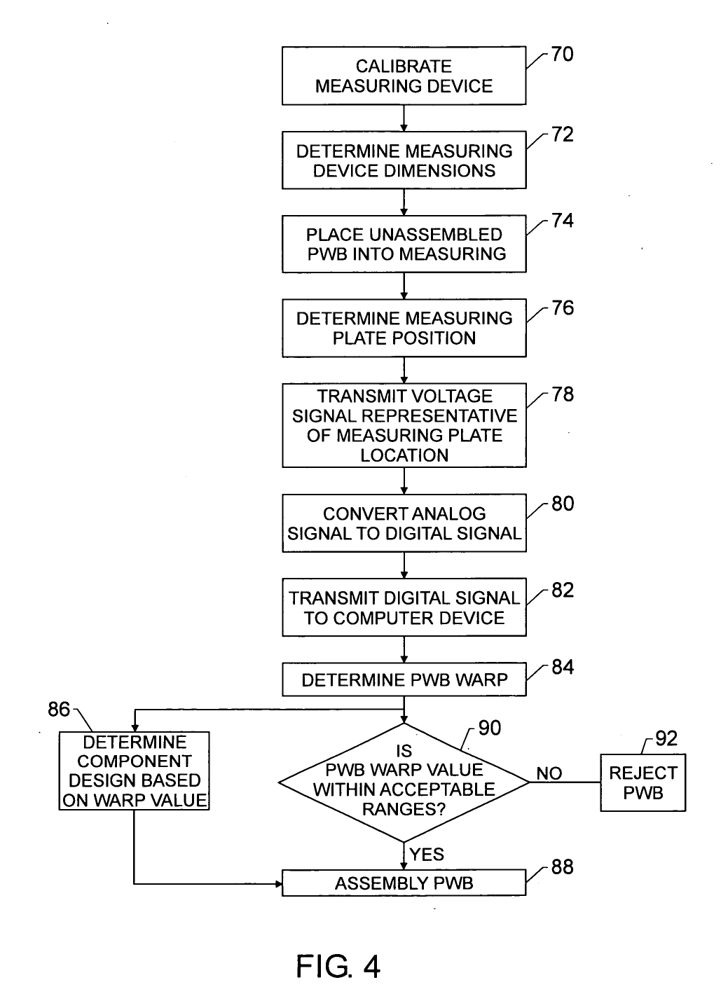

Keeping FIGS. 1-3 in mind, FIG. 4 illustrates an exemplary process for determining the amount of warpage in the PWB 32 via the measuring device 46. As illustrated by blocks 70 and 72, the exemplary process includes calibrating the measuring device 46 and determining the constant dimensions of the measuring device 46 (i.e., T_{PL} and D₁), if any. The exemplary process also includes placing an unassembled PWB 32 into the measuring device 46 between the measuring plate 52 and the backing plate 47. (Block 74). Because the PWB 32, more specifically the warpage of the PWB (W), defines the separation distance (D_{SEP}) between the measuring plate 52 and the backing plate 47, the exemplary process determines the position of the measuring plate 52 within the measuring device 46. (Block 76.)

Using the position of the measuring plate 52, a value indicative of the amount of warpage in the PWB 32 may be determined. In the subject example, the measuring device 46 comprises electronic components configured to determine the position of the measuring plate 52 within the device 46. (Block 78.) For example, the measuring device 46 includes an LVT located along the length or height of the post 48. Accordingly, when the measuring plate 52 is at a position closest to the backing plate 47, the LVT transmits a relatively small voltage signal; as the measuring plate 52 is moved towards the top plate 50 along the post 48 (thereby along the LVT), the LVT produces a larger voltage signal. Accordingly, the size of the voltage signal indicates the position of the measuring plate 52 with respect to the post 48. The LVT transmits this voltage signal to sensing circuitry 65. The sensing circuitry 65 then transmits the analog voltage signal to the ADC circuitry 66. (Block 80.) The ADC circuitry 66 produces a digital signal representative of the location of the measuring plate 52 within the measuring device 46, which is transmitted to the computer device 68. (Block 82.) The computer device 68 calculates the PWB warpage based upon the position of the measuring plate 52. The computer device 68 accomplishes this determination via a computer program having appropriate input values, such as known thickness values of the PWB (T_{PWB}) or the measuring plate (T_{PL}). (Block 84.)

If the amount of warpage in the PWB 32 is known, then various components coupled to and related to the PWB 32 may be designed to accommodate this value. For example, the socket springs of the interposer 38 may be adjusted to provide greater clamping forces accommodating the moment forces 44 caused by the warp in the PWB 32. (Block 86.) Once properly adjusted or designed, the component may be assembled to the PWB 32 for use in an electronic device. (Block 88.)

Additionally or alternatively, quality control protocols also utilize the determined amount of warpage in the PWB 32. For example, as represented by Block 90, the quality control protocols evaluate the determined amount of warpage in the PWB 32 and ascertain whether the amount of warpage in the PWB 32 falls within an acceptable range. If the amount of warpage of the PWB 32 falls outside the acceptable ranges set by the quality control protocols, then the PWB 32 is rejected. (Block 92.) If the quality control protocol, or testing, is conducted on an unassembled or raw PWB 32, the embodiment of the present invention enables the PWB 32 to be evaluated prior to the assembly of any components onto the PWB 32. Accordingly, if the PWB fails the quality control protocol, then the PWB 32 is discarded prior to any assembly, thereby conserving time and components. However, if the PWB 32 falls within the desired ranges of the protocols, the PWB 32 may be assembled. (Block 88.) The quality control protocols may be conducted automatically by an appropriately designed device or manually by a technician.

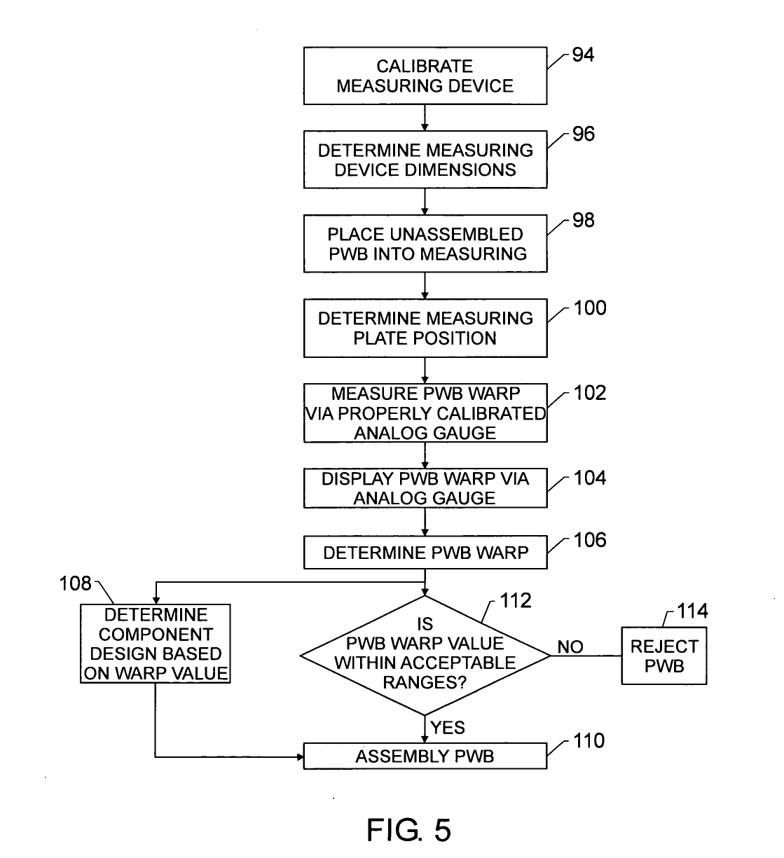

Keeping FIGS. 1-4 in mind, FIG. 5 illustrates an alternate process for determining an amount of warpage in a PWB. In this exemplary process, the functionalities represented by Blocks 94, 96, 98, and 100 correspond respectively with the functionalities represented by Blocks 70, 72, 74, and 76 of the process illustrated in FIG. 4. The exemplary process of FIG. 5 comprises calibrating the analog gauge 64 to measure the position of the measuring plate 52 with the amount of warpage in the PWB 32. (Blocks 102 and 104.)

Using the determined warpage of the PWB 32, a component design may be based on this value, in a manner corresponding with Block 86 of FIG. 4. (Block 108.) Once the component is designed, the PWB 32 may be appropriately assembled. (Block 110.) Additionally and/or alternatively, the process comprises quality control procedures, as represented by Blocks 112 and 114, that correspond respectively with the process of Blocks 90 and 92 of FIG. 4.

1. An apparatus, comprising:
a base structure;
a linking mechanism coupled to the base structure;
a measuring structure positionable with respect to the base structure; and
an output device configured to output an electrical signal indicative of the position of the measuring structure with respect to the base structure in response to a substrate disposed between the measuring structure and the base structure.

2. The apparatus as recited in claim 1, wherein the output device is configured to output a voltage signal indicative of the position of the measuring structure with respect to the base structure.

3. The apparatus as recited in claim 1, comprising a computer device configured to determine the quantity of warpage in the substrate based on the electrical signal and a value representative of a thickness of the substrate.

4. The apparatus as recited in claim 2, wherein the output device includes a linear voltage transformer (LVT) configured to develop the voltage signal.

5. The apparatus as recited in claim 1, wherein the output device comprises an analog gauge configured to produce a measurement representative of a distance between the base structure and the measuring structure

6. The apparatus as recited in claim 5, wherein the analog gauge comprises a micrometer.

7. The apparatus as recited in claim 1, wherein the linking mechanism comprises at least one post extending from the base structure.

8. The apparatus as recited in claim 7, wherein the linking mechanism is configured to produce a voltage signal indicative of the position of the measuring structure with respect to the at least one post.

9. The apparatus as recited in claim 1, comprising a top structure such that the measuring structure is located between top structure and the base structure, wherein the top structure limits the path of travel of the measuring structure.

10. The apparatus as recited in claim 1, wherein the base structure or the measuring structure or any combination thereof comprises a plate.

11. (canceled)

12. (canceled)

13. The apparatus as recited in claim 2, wherein the computer device is configured to determine the quantity of warpage in the substrate via the formula:
W=D_{SEP}−T_{PWB},
wherein W represents the quantity of warpage in the substrate, D_{SEP} represents a distance of separation between the measuring and base structures, and T_{PWB} represents a thickness of the substrate.

14. The apparatus as recited in claim 2, comprising a top structure such that the measuring structure is disposed between the top and base structures; wherein the computer device is configured to determine the quantity of warpage via the formula:
W=D₁−T_{PL}−T_{PWB}−D₂,
wherein W represents the quantity of warpage, D₁ represents the distance between the base and top structures, T_{PL} represents a thickness of the measuring structure, T_{PWB} represents a thickness of the substrate, and D₂ represents a distance between the measuring and top structures.

15. The apparatus as recited in claim 14, wherein D₁, T_{PL}, or T_{PWB} or any combination thereof is constant.

16. The apparatus as recited in claim 1, wherein the substrate comprises a printed wiring board (PWB).

17. (canceled)

18. A method for determining an amount of warpage in a printed wiring board (PWB), comprising:
providing the PWB to a measuring device having a measuring structure and a base structure such that the measuring and base structures cooperate to receive the PWB therebetween; and
determining the amount of warpage in the PWB based on a distance maintained between the measuring and base structures by the PWB.

19. The method as recited in claim 18, comprising determining a design parameter of a component coupleable to the PWB based on the determined amount of warpage in the PWB.

20. The method as recited in claim 18, comprising determining a design parameter of an interposer based on the determined amount of warpage in the PWB.

21. The method as recited in claim 20, comprising determining clamping forces to be provided by the socket springs of the interposer to a processor coupleable to the PWB in response to the determined amount of warpage in the PWB.

22. The method as recited in claim 18, comprising determining if the amount of warpage is within a pre-defined acceptable range.

23-28. (canceled)

29. An apparatus, comprising:
means for linking a measuring structure with respect to a base structure; and
means for producing an electrical signal representative of the position of measuring structure with respect to the base structure to determine an amount of warpage in a printed wiring board (PWB) disposed between the base structure and measuring structure based on the electrical signal and a thickness of the PWB.

30. The apparatus as recited in claim 29, comprising means for displaying the amount of warpage in the substrate.

31. The apparatus as recited in claim 29, comprising means for computing the amount of warpage in the substrate based on the electrical signal and the thickness of the PWB.

32. A method of manufacturing a computer device, comprising:
determining a quantity of warpage in a printed wiring board (PWB) for the computer device via a measuring device having a measuring structure positionable with respect to a base structure; and
adjusting a design parameter of a component coupleable to the PWB based on the determined quantity of warpage.

33. The method as recited in claim 32, comprising adjusting clamping forces provided by an interposer to a processor to be coupled to the interposer based on the determined quantity of warpage.

34. The method as recited in claim 33, comprising adjusting socket springs of the interposer to change the clamping forces provided by the socket springs to a processor to be coupled to the interposer based on the determined quantity of warpage.

35. A method for determining a quantity of warpage in a printed wiring board (PWB), comprising:
developing a signal representative of displacement of a measuring structure of a measuring device in response to placement of the PWB in the measuring device; and
calculating the quantity of warp in the PWB based on a thickness of the PWB and the signal representative of displacement of the measuring structure.

36. The method as recited in claim 35, comprising:
calculating the quantity of warp in the PWB based on the formula:
W=D_{SEP}−T_{PWB},
wherein W represents the quantity of warpage, D_{SEP} represents a distance of separation between the measuring structure and a base structure of the measuring device, and T_{PWB} represents the thickness of the PWB.
